(19) United States
(12) Patent Application Publication
(10) Pub. No.: US 2020/0167718 A1
(43) Pub. Date: May 28, 2020

(54) Automated Organization of a Space Background

(71) Applicant: International Business Machines Corporation, Armonk, NY (US)

(72) Inventors: Romelia H. Flores, Keller, TX (US); Roberto Ramon Rodriguez, Irving, TX (US); Ronald Joseph Rutkowski, II, Irving, TX (US); Michael Anson Lau, Arlington, TX (US); Marlentae Johnson, Irving, TX (US); Travis Wah Chun, Coppell, TX (US)

(21) Appl. No.: 16/202,578

(22) Filed: Nov. 28, 2018

(51) Int. Cl. G06Q 10/08

(52) U.S. Cl. CPC G06Q 10/087

(57) ABSTRACT

A method of automating organization of a defined space is provided. Spatial data about the defined space and location data of objects in the defined space are received from a number of input devices. A baseline organization scheme of objects in the defined space is created. User profile data is received for an organizer, and a recommended organization scheme of items in the defined space is created based on comparison of the baseline organization scheme with the user profile data for the organizer. A presentation of the recommended organization scheme is generated by a number of user interfaces. Locations of items in the defined space relative to the recommended reorganization scheme are monitored utilizing a number of sensors, and an alert is sent to the organizer if locations of items in the defined space deviate from the recommended organization scheme beyond a predefined threshold.

### BACKGROUND

### 1. Field

The disclosure relates generally to image analytics and organizational management systems, and more specifically to a system for customizing and maintaining an organization scheme according to user needs.

### 2. Description of the Related Art

Image analytics is the automatic algorithmic transformation from images to analytical data. Examples of image analysis include reading codes and quick response (QR) codes, facial recognition, 2D and 3D object recognition, and motion detection.

Image analytics transforms images into a machine-readable format. To perform analytics on images, geometric encoding is transformed into constructs depicting features, objects, and movement represented by the image that can be logically analyzed by a computer. Images are first segmented into structured elements. Segmentation partitions an image into a collection of connected sets of pixels, which helps to identify certain features in the image. Segments are spatially relevant regions of an image with a common set of features.

Next, relationships between the variables, features, and time are detected and time stamped for time series analysis, and variables are then extracted. A variable is represented by a series of values related to an entity. To detect relationships between variables, features and time, machine learning is typically combined with applied statistics to create a relationship intelligence, wherein the relationships are represented as a predictive model. Objects have statistics associated with them which can be used to classify objects including geometry, edges, context, and texture.

A machine learning or statistical modeling algorithm trains the predictive model based on the set of annotated training instances. Modeling algorithms can be based on techniques including, e.g., neural networks, scalable vector machines, function learning, Bayesian networks, and regression. Test instances are used to calculate the accuracy of a predictive model created by a modeling algorithm. The training process is typically repeated with different sets of training and test instances and/or algorithm parameters until the accuracy of the predictive model is at an acceptable level. After the predictive model has been trained, it is used to classify predicted instances. In prescriptive analytics structured and unstructured data are processed to create a set of suggested future actions.

### SUMMARY

A method of automating organization of a defined space is provided. Spatial data about the defined space and location data of objects in the defined space are received from a number of input devices. A baseline organization scheme of objects in the defined space is created. User profile data is received for an organizer, and a recommended organization scheme of items in the defined space is created based on comparison of the baseline organization scheme with the user profile data for the organizer. A presentation of the recommended organization scheme is generated. Locations of items in the defined space relative to the recommended reorganization scheme are monitored utilizing a number of sensors, and an alert is sent to the organizer if locations of items in the defined space deviate from the recommended organization scheme beyond a predefined threshold.

A system for automating organization of a defined space is provided. The system comprises a bus system, a storage device connected to the bus system, wherein the storage device stores program instructions, and a number of processors connected to the bus system, wherein the processors execute the program instructions to: receive, from a number of input devices, spatial data about the defined space; receive, from a number of input devices, location data of objects in the defined space; create a baseline organization scheme of objects in the defined space; receive, from a number of input devices, user profile data for an organizer; create a recommended organization scheme of items in the defined space based on comparison of the baseline organization scheme with the user profile data for the organizer; generating, by a number of user interfaces, a presentation of the recommended organization scheme; monitor, by a number of sensors, locations of items in the defined space relative to the recommended reorganization scheme; and sending an alert to the organizer, by a number of output devices, if locations of items in the defined space deviate from the recommended organization scheme beyond a predefined threshold.

A computer program product for automating organization of a defined space is provided that comprises a non-volatile computer readable storage medium having program instructions embodied therewith and the program instructions executable by a computer to cause the computer to perform the steps of: receiving spatial data about the defined space; receiving location data of objects in the defined space; creating a baseline organization scheme of objects in the defined space; receiving user profile data for an organizer; creating a recommended organization scheme of items in the defined space based on comparison of the baseline organization scheme with the user profile data for the organizer; generating a presentation of the recommended organization scheme; monitoring locations of items in the defined space relative to the recommended reorganization scheme; and sending an alert to the organizer if locations of items in the defined space deviate from the recommended organization scheme beyond a predefined threshold.

### BRIEF DESCRIPTION OF THE DRAWINGS

FIG. 1 depicts a pictorial representation of a network of data processing systems in which illustrative embodiments can be implemented;

FIG. 2 depicts an automated space organization system in accordance with illustrative embodiments;

FIG. 3 depicts a user interface for configuring a profile regarding a particular physical space in accordance with illustrative embodiments;

FIG. 4 depicts a user interface for alerting a user to item misplacement in accordance with illustrative embodiments;

FIG. 5 depicts a user interface for categorization of items and zones within a physical space in accordance with illustrative embodiments;

FIG. 6 depicts a user interface for monitoring of items within a space in accordance with illustrative embodiments;

FIG. 7 depicts a user interface for performing an item search query in accordance with illustrative embodiments;

FIG. 8 is a flowchart depicting a process flow for automatically organizing a space in accordance with illustrative embodiments; and

FIG. 9 is a diagram of a data processing system is depicted in accordance with an illustrative embodiment.

### DETAILED DESCRIPTION

Aspects of the present invention are described herein with reference to diagrams of methods and apparatuses according to embodiments of the invention. The diagrams in the Figures illustrate the architecture and operation of possible implementation methods according to various embodiments of the present invention.

Illustrative embodiments of the present disclosure recognize and take into account that the task of organizing spaces such as pantries, cupboards, cabinets, drawers, closets, and rooms is a common problem that many people face in both their personal and professional life. Most spaces are organized by first choosing a particular set of patterns or rules, and then arranging the items in that space according to those rules. These rules often require a categorization of the items within the space by their type, color, size, expiration date, or other attributes. Even though the organizational rules of a space may be obvious to the individuals that chose them, other users of the space may not know of or be able to recognize how items were originally intended to be grouped and arranged. As a result, the space becomes disorganized over time as objects are moved from their original location.

Illustrative embodiments of the present disclosure also recognize and take into account that as a space becomes more and more disorganized, items can easily become misplaced and go unused. This results in a waste of money if the item expires before it is found, and a waste of time spent looking for misplaced items that are not in the correct location. When multiple spaces require reorganizing, typically the users of those spaces must apply their best judgment to determine which space is the most disorganized and therefore takes priority in being reorganized first. Currently, there is no single method or system for organizing a pantry or room or similar defined space, capturing the organization technique, rating multiple spaces by their degree of disorganization, and providing notifications of how to maintain organization.

The present disclosure provides a system and method for organizing items within physical spaces. The system is accessible through different types of interfaces including, but not limited to, a mobile application or web interface. The system provides the ability to tag system users as space organizers or collaborators that share a particular space. The system enables profiles to be kept for each user with information regarding that user's height, health, or other limitations that the user might have.

The system user identifies a space (e.g., pantry, cupboard, closet, drawer, etc.) and captures the organization created in the space. The system enables the user to identify the items located in the space, as well as the categories those items belong to, through video or image capture. The system also lets users correlate LED lighting and sensors (e.g., weight, size, etc.) to the items contained within the space in order to help specify and monitor the location of each item and indicate their proper replacement. The space, categories, items, lighting, and sensor information are used to create the baseline configuration for the space.

The baseline configuration and user profile information are used to analyze the space and provide preliminary reorganization recommendations. For example, if a particular user is only five feet tall, it might be important to store items the user should be able to reach in lower parts of the space where they are more accessible.

Once this baseline configuration is in place, the user can configure both automated and manual monitoring of changes within the space. Automated monitoring can be done through the use of video cameras or Internet of Things (IoT) sensors within or near the space, complimented with video and data analytics. Manual monitoring can be performed by a user when the user wishes to understand the deviation from the baseline. This manual monitoring can be through image capture combined with image analytics that is provided by the system. The user can identify thresholds of disorganization the user is willing to accept for each space in the system. For example, the user may be willing to tolerate 75% disorganization in the pantry but might want 100% organization in a medicine cabinet. In addition, the user can specify which space collaborators should be automatically alerted to particular levels of disorganization for each individual space in the system. For example, a user (parent) may wish to have automated alerts sent to a collaborator (child) when the collaborator's space (room) has reached a certain level of disorganization.

When a threshold has been crossed and a user needs to rearrange the items in a space to match the baseline configuration, the sensors and LED lighting can be used to indicate which items need to be adjusted to return the space to its baseline. The system can also analyze the video, image, and other sensor data to calculate metrics for all spaces and system users. These metrics can indicate which space becomes disorganized the most, which user keeps their space the most or least organized, which items are used the most or least often, etc. This information can be shared among the system users to help coordinate organization across multiple spaces.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

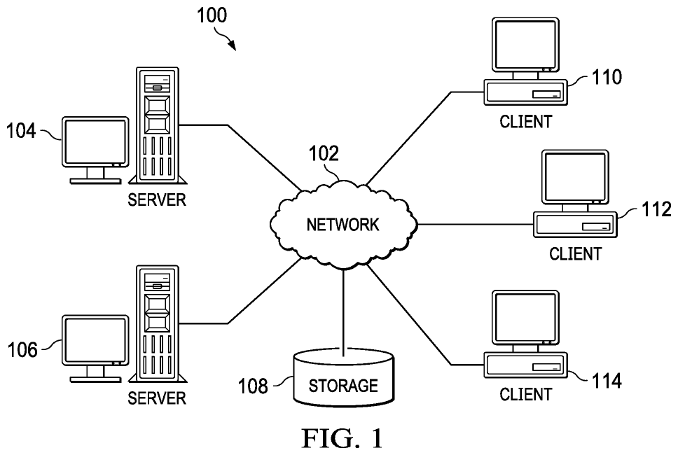

FIG. 1 depicts a pictorial representation of a network of data processing systems in which illustrative embodiments can be implemented. Network data processing system 100 is a network of computers, data processing systems, and other devices in which the illustrative embodiments may be implemented. Network data processing system 100 contains network 102, which is the medium used to provide communication links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may provide a set of one or more connector services for managing idempotent operations on a system of record, such as storage 108. An idempotent operation is an identical operation, which was previously performed or executed, that has the same effect as performing a single operation. Also, it should be noted that server 104 and server 106 may each represent a plurality of servers providing management of idempotent operations for a plurality of system of records.

Client 110, client 112, and client 114 also connect to network 102. Clients 110, 112, and 114 are clients of server 104 and server 106. Server 104 and server 106 may provide information, such as boot files, operating system images, and software applications to clients 110, 112, and 114.

In this example, clients 110, 112, and 114 are shown as desktop or personal computers. However, it should be noted that clients 110, 112, and 114 are intended as examples only. In other words, clients 110, 112, and 114 may include other types of data processing systems, such as, for example, network computers, laptop computers, tablet computers, handheld computers, smart phones, smart watches, personal digital assistants, gaming devices, set-top boxes, kiosks, and the like. Users of clients 110, 112, and 114 may utilize clients 110, 112, and 114 to access system of records corresponding to one or more enterprises, via the connector services provided by server 104 and server 106, to perform different data operations. The operations may be, for example, retrieve data, update data, delete data, store data, and the like, on the system of records.

Storage 108 is a network storage device capable of storing any type of data in a structured format or an unstructured format. In addition, storage 108 may represent a plurality of network storage devices. Further, storage 108 may represent a system of record, which is an authoritative data source, corresponding to an enterprise, organization, institution, agency, or similar entity. Furthermore, storage unit 108 may store other types of data, such as authentication or credential data that may include user names, passwords, and biometric data associated with client users and system administrators, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), and a wide area network (WAN). FIG. 1 is intended as an example only, and not as an architectural limitation for the different illustrative embodiments.

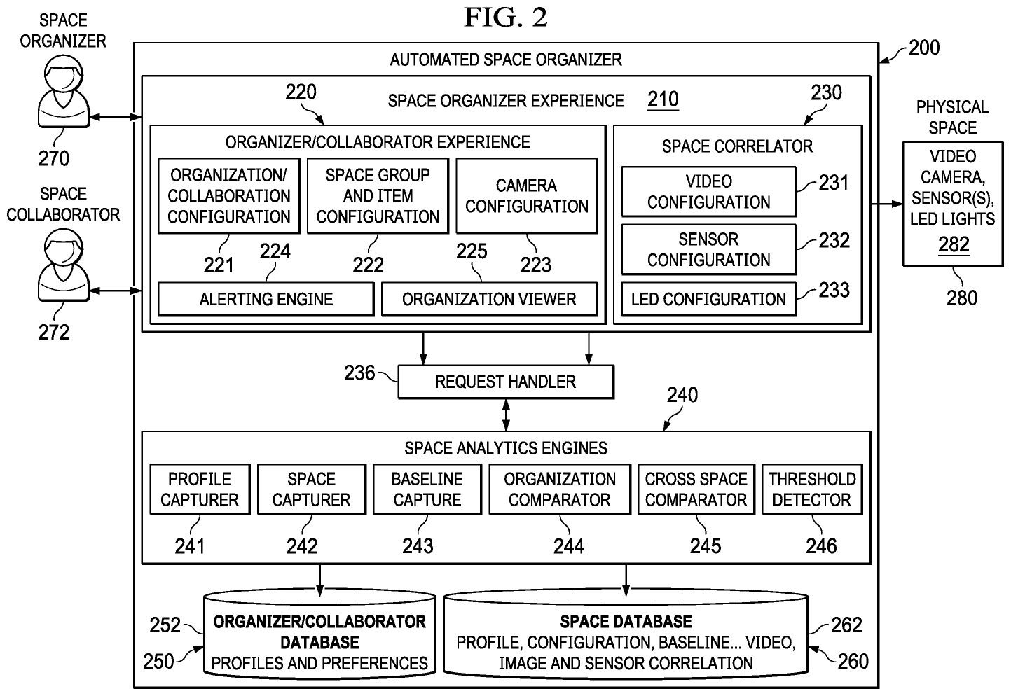

FIG. 2 depicts an automated space organization system 200 in accordance with illustrative embodiments. The automated space organizer 200 is used by a space organizer 270, who is the primary user responsible for the organization of a physical space 280. This space can be any define space that contains objects including, without limitation, a cupboard, closet, pantry, office, bedroom, kitchen, etc. The organizer 270 can utilize a mobile or web interface to interact with the space organizer system 200 on the identification of space collaborators, spaces, groupings/categories, items, configurations, alerting and thresholds in support of the system.

A space collaborator 272 is a co-user of the automated space organizer system 200 who collaborates with space organizer 270 on the organization of a physical space 280. The collaborator 272 leverages the system to understand spaces and their associated groupings/categories and items. The collaborator 272 utilizes a mobile or web interface to interact with the automated space organizer system 200 and receive alerts and inquire about space thresholds to maintain organization of a space.

The system supports the creation of profiles for space organizers 270 and collaborators 272 associated with particular spaces and their respective accessibility preferences and restrictions. In addition, the system supports creation of space profiles to understand which spaces have special features such as dimensions, layout, locks, empty space, etc. This enables the system to detect potentially dangerous items like chemical items and recommend storing in locked space or out of reach of young collaborators (i.e. children).

The space organizer experience 210 is one of the three major components of the system and consists of two aspects, the organizer/collaborator experience 220 and the space correlator 230.

The organizer/collaborator experience 220 provides the user interface to support organizers 270 and collaborators 272 in their interactions with the system through either a mobile or web interface. The organizer/collaborator configuration unit 221 is a sub-component that supports the creation of user profiles for space organizers 270 and collaborators 272 associated with particular spaces and their accessibility preferences and restrictions. Furthermore, it collects appropriate profile information from the user and creates a request to be sent to the request handler 236 and funnels this request to the profile capturer 241 for appropriate handling.

The space, group and item configuration unit 222 is a sub-component that supports the collection of space, group and item configuration information and creates a request to be sent to the request handler 236 that is routed to the space capturer 242 for appropriate handling. This unit supports the organization of items in a coordinated manner based on organizer created groupings/categories and item identification.

The camera configuration unit 223 is a sub-component that supports the collection of camera images submitted by a space organizer 270 or collaborator 272 and creates a request to be sent to the request handler 236. The data flows to the request handler 236 for appropriate handling.

The alerting engine 224 is a sub-component providing short message service (SMS) messaging to organizers 270 and collaborators 272. This sub-component is triggered when the threshold detector 246 determines that a threshold previously configured by an organizer 270 has been reached.

The organization viewer 225 is a sub-component that produces a user interface (web or mobile) that an organizer 270 or collaborator 272 can leverage to understand disorder thresholds, item movement, organization levels, or organizers and collaborators, recommendations, etc.

The space correlator 230 is the other aspect of the space organizer experience 210. This major component provides the user interface to support organizers 270 and collaborators 272 in their interactions with the system through either a mobile or web interface. The space correlator 230 is leveraged by the users to correlate physical spaces with a video camera, sensor(s), and LED lights. The defined physical space 280 includes video camera, sensor(s), and LED lights 282 that are available to the space correlator 230 to establish video baselines, real-time video capture, sensor base lines, real-time sensor data capture and LED light configuration and activation. LED lighting and sensors located in a space according to space organization (categories/groups) enables visual indication of item placement and misplacement within a space to guide users to the correct location.

The video configuration unit 231 is a sub-component of the space correlator 230 that supports the correlation and configuration of video cameras located within the physical space 280. It can be utilized to calibrate the video equipment as well as determine the frequency of video capture capabilities supported by the system.

The sensor configuration unit 232 is a sub-component that supports the correlation and configuration of IoT sensors located within a physical space. A variety of IoT sensors can be supported such as, e.g., weight sensors, movement sensors, height sensors, etc. This sub-component can be utilized to calibrate the sensors as well as determine the frequency of sensor data feeds supported by the system.

The LED configuration unit 233 is a sub-component of the space correlator 230 that supports the correlation and configuration of LED lights located within a physical space. This sub-component can be utilized to calibrate the LED lights as well as determine LED light configurations associated with categories/groups within a space.

The request handler 236 is the second major component of the automated space organizer system 200 which handles the routing of interactions/communication between the space organizer experience 210 and the space analytics engine 240. The space analytics engine 240 is the third major component of the automated space organizer system 200. This component contains all of the sub-components responsible for storing relevant information in support of the automated space organizer system 200 as well as driving the analytics and threshold detection required to support the overall system.

The profile capturer 241 is a sub-component of the space analytics engine 240 that provides the ability to receive requests from the request handler 236 to capture organizer or collaborator information and changes in order to update the organizer/collaborator database 250. The organizer/collaborator database 250 is a database system that contains user profile and preference information 252 for the organizers 270 and collaborators 272 using the system.

The space capturer 242 provides the ability to receive requests from the request handler 236 to capture space, dimensions, group/category, and item information and changes in order to update the space database 260. The space database 260 contains space information 262 such as, e.g., spaces profiles, configurations, baselines, thresholds, captures in support of the automated space organizer system 200.

The baseline capturer 243 receives requests from the request handler 236 to capture a new baseline created by an organizer 270 in support of a particular space 280. Baseline captures are stored in the space database 260.

The organization comparator 244 provides the analytics required to compare video, image or sensor information captured automatically or manually by the system and provides a comparison from the baseline that exists for the space 280. The organization comparator 244 makes recommendations that are sent to the request handler 236 for presentation to the organizer 270 or collaborator(s) 272 of the space 280.

The cross space comparator 245 provides the analytics to compare the organization level of various spaces which have been configured by the organizer 270. Thresholds configured by the system are used to determine whether the size of a space should be taken into account in the organization calculation or simply the deviation from the original baseline for each space.

The threshold detector 246 provides the continual processing required to determine whether the various thresholds configured for each space have been reached. The threshold detector 246 provides the ability to send requests to the request handler 236 in order to trigger appropriate alerting to an organizer 270 or collaborator 272 of the space 280.

The automated space organizer system 200 provides preliminary reorganization recommendations based on space organization baseline and space organizer and collaborator profiles. For example, the system can recommend storing items in a space to enable or disable accessibility for collaborators of a certain age/height (i.e. children). Another example of recommendations can be for food placement in organization spaces to help ensure the user's health/safety (e.g., preventing accidental ingestion of food items which have been in close proximity to other items containing ingredients to which the user is allergic). Another example is enabling collaborators (e.g., children) to not have access to a medicine cabinet, but having access to a snack drawer/pantry.

The system also supports automated and manual system monitoring of spaces through identification of thresholds of space disorganization as well as appropriate collaborators to keep the organizer(s) informed of space organization requirements. For example, when a collaborator's room has reached a threshold of disorganization, an automated message is provided to the individual identified by the organizer for that space so they can address the disorganization in a timely manner. Another example of monitoring is alerting of an organizer about medications in a medicine cabinet which may need refilling based on weight sensor information. Another example is if a surgeon's medical instrument tray is missing a particular instrument, ensuring a collaborator (i.e. nurse) is aware of this requirement. Another example of automated monitoring includes the proactive sensing of items being utilized by sensors detecting the current particular weight of specific items associated with a sensor as comparted to the original baseline.

With organizational schemes and monitoring in place, the system provides recognition of disorder thresholds, item movement, and organization levels of organizers and collaborators. This capability enables organizers and collaborators to understand which items with low utilization/value can be donated or discarded, which spaces need organization (prioritization across all spaces), and other similar operational decisions.

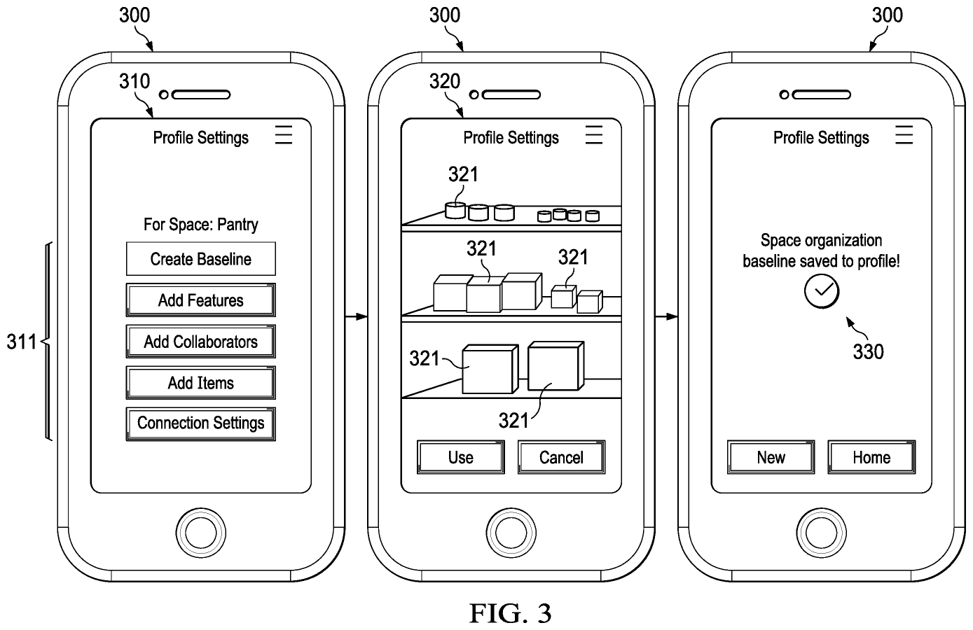

FIG. 3 depicts a user interface for configuring a profile regarding a particular physical space in accordance with illustrative embodiments. In the present example, a user can interact with an interface 310 on a mobile device 300 for configuring a profile for a physical space named “Pantry.” The user is presented with options 311 for manually adding collaborators, manually defining features, or items associated with the physical space, and options for connecting to sensors belonging to the physical space. In this particular example the user sets a baseline using a picture image 320 of the physical space to define the correct placement of items 321 within that physical space. Afterwards, a confirmation 330 is received indicating the system has been trained to recognize the correct placement of items.

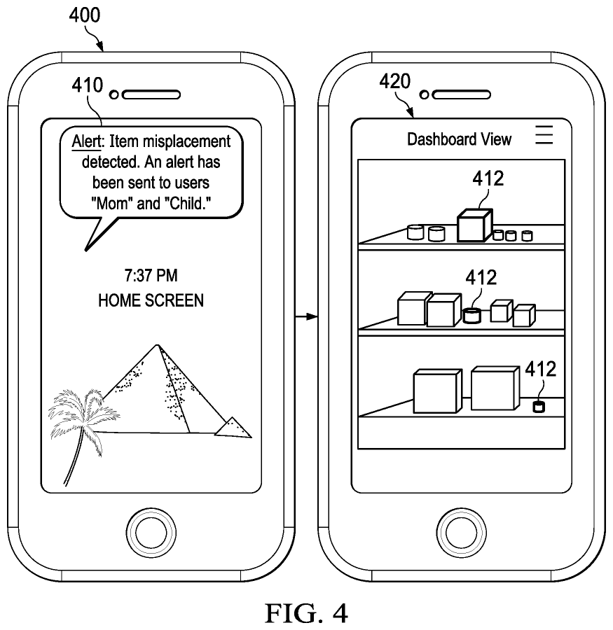

FIG. 4 depicts a user interface for alerting a user to item misplacement in accordance with illustrative embodiments. In this example, using the baseline configured for a household pantry as seen in FIG. 3, the system uses visual comparison of an updated image of the pantry to determine that items have been misplaced within the space after a comparison of the current status of the physical space against the space's baseline. As a result, all the collaborators associated with the space receive a notification 410 on a mobile device 400. When the user activates the interface misplaced items 412 are highlighted in an image on the interface 420. The highlighting on the interface can be complemented by LED lights within the physical space to highlight the item(s) in question as well as their proper location.

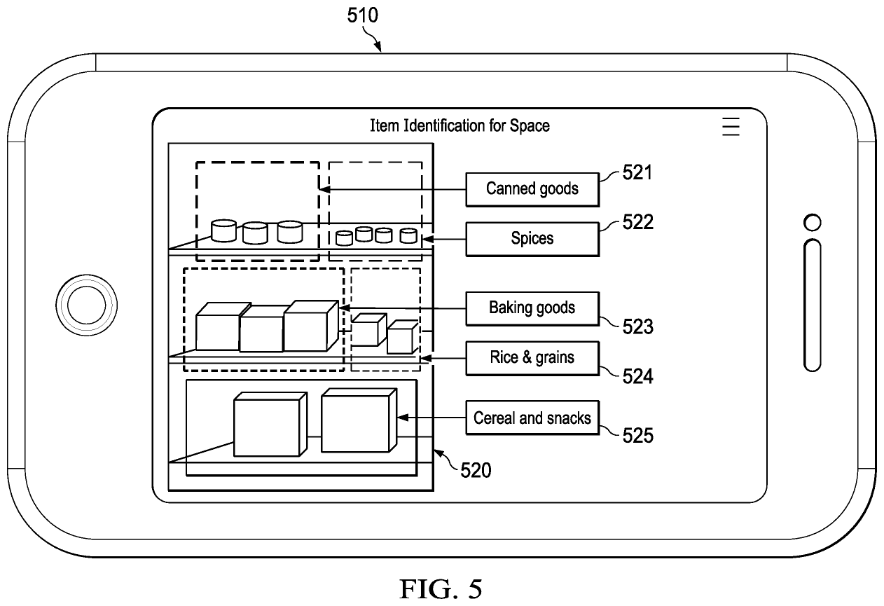

FIG. 5 depicts a user interface for categorization of items and zones within a physical space in accordance with illustrative embodiments. The system enables a user to manually define metadata, catagories, and other information related to physical items resting within a particular physical space. In present example, the interface 510 displays an image of a space 520 and items stored within that space. The items have been grouped into different categories 521-525. The items are grouped into food catagories as well as defining zones where each category of items belongs in the physical space 520 according to user supplied metadata.

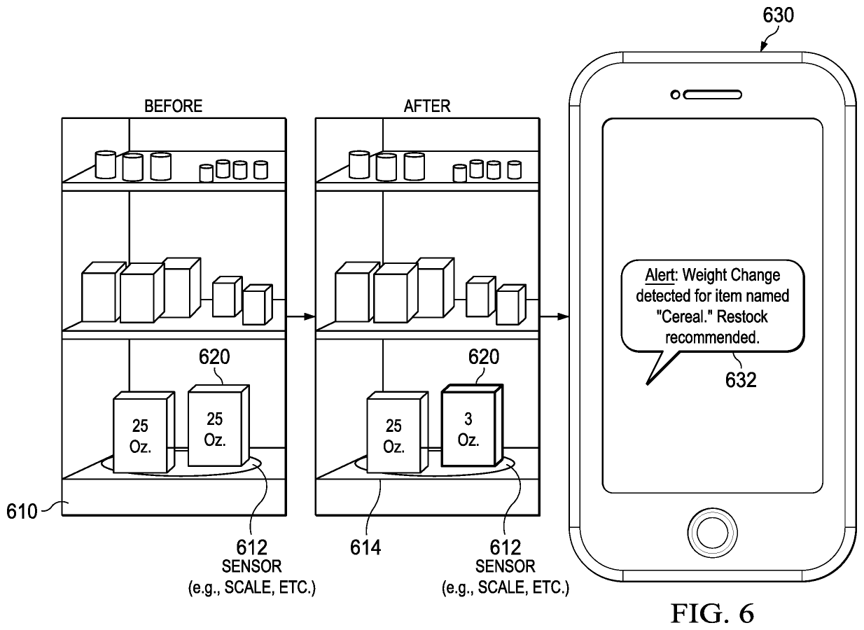

FIG. 6 depicts a user interface for monitoring items within a space in accordance with illustrative embodiments. FIG. 6 illustrates the system's ability to identify, track, and log changes regarding items of a particular physical space using IoT sensors. In this example an item 620 in space 610 that originally weighed 25 ounces (left) now only weighs 3 ounces (right). The weight data is provided by sensors 612 incorporated into the shelf 614. As a result of the weight change exceeding a threshold value, the system sends a notification 632 to the user on a mobile device 630 or other output device.

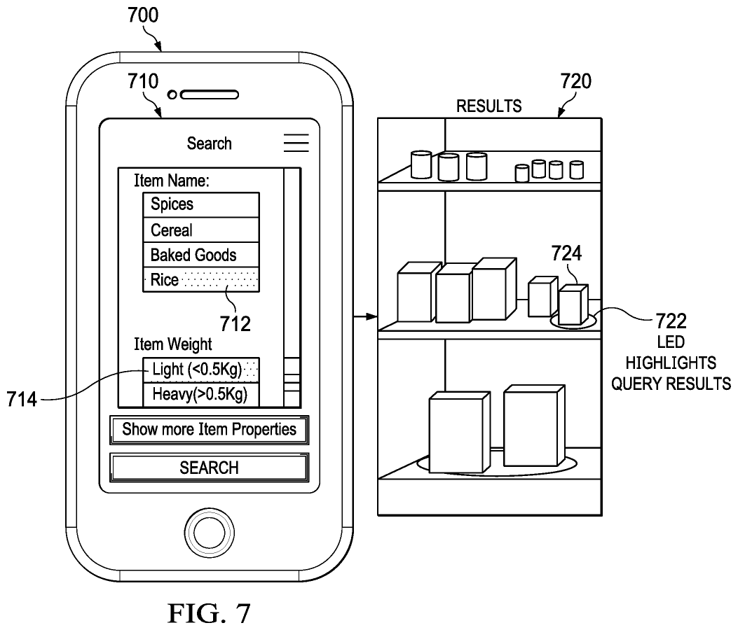

FIG. 7 depicts a user interface for performing an item search query in accordance with illustrative embodiments. FIG. 7 depicts an example of querying the items within a physical space after items have been identified and associated metadata has been generated for each item. In this example the user accesses a query interface 710 on a mobile device 700. The user searches for the item according to one or more properties such item name 712 and/or weight 714. After submitting the query, the item 724 that was the subject of the query is indicated in the physical space 720. In this particular embodiment, results are flagged via physical LED indicators 722 within the physical space 720.

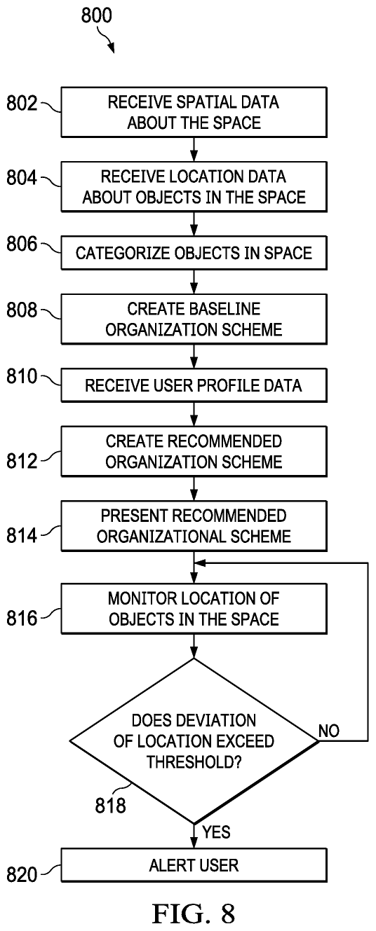

FIG. 8 is a flowchart depicting a process flow for automatically organizing a space in accordance with illustrative embodiments. Process 800 begins by receiving spatial data for a defined space (step 802). Next the system receives input data regarding objects in the space including their current location (step 804). The system categorizes the objects in the space (step 806) and creates a baseline organization scheme for the objects in the space (step 808).

The system receives user profile data from an organizer (step 810). The system can also receive additional user profile data for a number of collaborators. The system compares the baseline organization scheme with the user profile data and creates a recommended organization scheme (step 812) and presents the recommended scheme to the user on an interface display (step 814).

The system monitors the location of objects in the space (step 816) and determines if the cumulative deviation of the objects exceeds a predefined threshold (i.e. disorder threshold) (step 818). If the deviation from the organizational scheme exceeds the threshold, the system alerts the user (step 820).

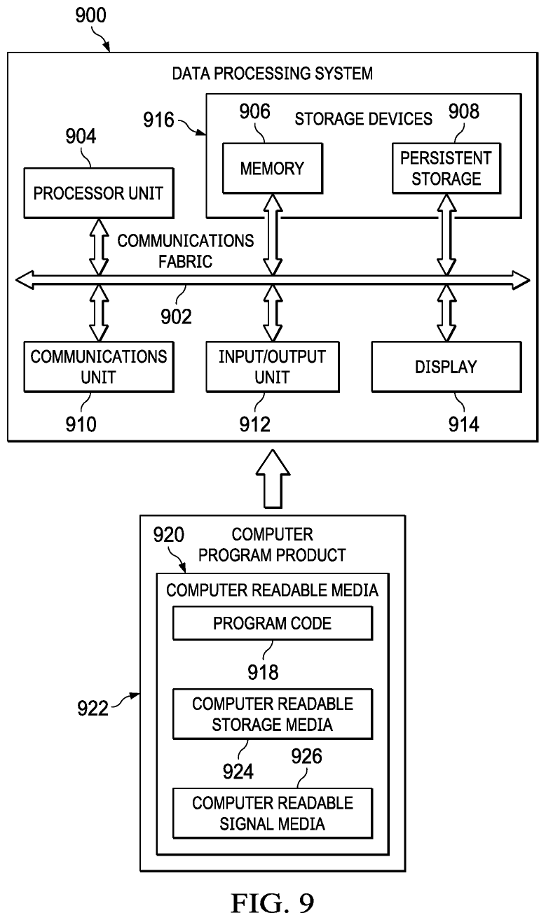

Turning to FIG. 9, a diagram of a data processing system is depicted in accordance with an illustrative embodiment. Data processing system 900 is an example of a system in which computer-readable program code or program instructions implementing processes of illustrative embodiments may be run. In this illustrative example, data processing system 900 includes communications fabric 902, which provides communications between processor unit 904, memory 906, persistent storage 908, communications unit 910, input/output unit 912, and display 914.

Processor unit 904 serves to execute instructions for software applications and programs that may be loaded into memory 906. Processor unit 904 may be a set of one or more hardware processor devices or may be a multi-processor core, depending on the particular implementation. Further, processor unit 904 may be implemented using one or more heterogeneous processor systems, in which a main processor is present with secondary processors on a single chip. As another illustrative example, processor unit 904 may be a symmetric multi-processor system containing multiple processors of the same type.

A computer-readable storage device is any piece of hardware that is capable of storing information, such as, for example, without limitation, data, computer-readable program code in functional form, and/or other suitable information either on a transient basis and/or a persistent basis. Further, a computer-readable storage device excludes a propagation medium. Memory 906, in these examples, may be, for example, a random-access memory, or any other suitable volatile or non-volatile storage device. Persistent storage 908 may take various forms, depending on the particular implementation. For example, persistent storage 908 may contain one or more devices. For example, persistent storage 908 may be a hard drive, a flash memory, a rewritable optical disk, a rewritable magnetic tape, or some combination of the above. The media used by persistent storage 908 may be removable. For example, a removable hard drive may be used for persistent storage 908.

Communications unit 910, in this example, provides for communication with other computers, data processing systems, and devices via network communications fabric 902 may provide communications using both physical and wireless communications links. The physical communications link may utilize, for example, a wire, cable, universal serial bus, or any other physical technology to establish a physical communications link for data processing system 900. The wireless communications link may utilize, for example, shortwave, high frequency, ultra-high frequency, microwave, wireless fidelity (WiFi), Bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 900.

Input/output unit 912 allows for the input and output of data with other devices that may be connected to data processing system 900. For example, input/output unit 912 may provide a connection for user input through a keypad, keyboard, and/or some other suitable input device. Display 914 provides a mechanism to display information to a user and may include touch screen capabilities to allow the user to make on-screen selections through user interfaces or input data, for example.

Instructions for the operating system, applications, and/or programs may be located in storage devices 916, which are in communication with processor unit 904 through communications fabric 902. In this illustrative example, the instructions are in a functional form on persistent storage 908. These instructions may be loaded into memory 906 for running by processor unit 904. The processes of the different embodiments may be performed by processor unit 904 using computer-implemented program instructions, which may be located in a memory, such as memory 906. These program instructions are referred to as program code, computer-usable program code, or computer-readable program code that may be read and run by a processor in processor unit 904. The program code, in the different embodiments, may be embodied on different physical computer-readable storage devices, such as memory 906 or persistent storage 908.

Program code 918 is located in a functional form on computer-readable media 920 that is selectively removable and may be loaded onto or transferred to data processing system 900 for running by processor unit 904. Program code 918 and computer-readable media 920 form computer program product 922. In one example, computer-readable media 920 may be computer-readable storage media 924 or computer-readable signal media 926. Computer-readable storage media 924 may include, for example, an optical or magnetic disc that is inserted or placed into a drive or other device that is part of persistent storage 908 for transfer onto a storage device, such as a hard drive, that is part of persistent storage 908. Computer-readable storage media 924 also may take the form of a persistent storage, such as a hard drive, a thumb drive, or a flash memory that is connected to data processing system 900. In some instances, computer-readable storage media 924 may not be removable from data processing system 900.

Alternatively, program code 918 may be transferred to data processing system 900 using computer-readable signal media 926. Computer-readable signal media 926 may be, for example, a propagated data signal containing program code 918. For example, computer-readable signal media 926 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer-readable media also may take the form of non-tangible media, such as communication links or wireless transmissions containing the program code.

In some illustrative embodiments, program code 918 may be downloaded over a network to persistent storage 908 from another device or data processing system through computer-readable signal media 926 for use within data processing system 900. For instance, program code stored in a computer-readable storage media in a data processing system may be downloaded over a network from the data processing system to data processing system 900. The data processing system providing program code 918 may be a server computer, a client computer, or some other device capable of storing and transmitting program code 918.

The different components illustrated for data processing system 900 are not meant to provide architectural limitations to the manner in which different embodiments may be implemented. The different illustrative embodiments may be implemented in a data processing system including components in addition to, or in place of, those illustrated for data processing system 900. Other components shown in FIG. 9 can be varied from the illustrative examples shown. The different embodiments may be implemented using any hardware device or system capable of executing program code. As one example, data processing system 900 may include organic components integrated with inorganic components and/or may be comprised entirely of organic components excluding a human being. For example, a storage device may be comprised of an organic semiconductor.

As another example, a computer-readable storage device in data processing system 900 is any hardware apparatus that may store data. Memory 906, persistent storage 908, and computer-readable storage media 924 are examples of physical storage devices in a tangible form.

In another example, a bus system may be used to implement communications fabric 902 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 906 or a cache such as found in an interface and memory controller hub that may be present in communications fabric 902.

The present invention may be a system, a method, and/or a computer program product. The computer program product may include a computer-readable storage medium or media having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer readable program instructions to personalize the electronic circuitry, in order to perform aspects of the present invention.

These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Furthermore, it should be understood that embodiments discussed herein are not limited to the particular features and processing steps shown. The descriptions provided herein are not intended to encompass all of the steps that may be used to form a functional integrated circuit device. Certain steps that are commonly used in fabricating such devices are purposefully not described herein for economy of description.

The flowchart and diagrams in the figures illustrate the method and resulting architecture according to embodiments of the present disclosure. In this regard, each block in the flowchart or structural diagrams may represent a step or partial step, which comprise one or more procedures for implementing the illustrative embodiments. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of automating organization of a defined space, the method comprising:
receiving, from a number of input devices, spatial data about the defined space;
receiving, from a number of input devices, location data of objects in the defined space;
creating, by a number of processors, a baseline organization scheme of objects in the defined space;
receiving, from a number of input devices, user profile data for an organizer;
creating, by a number of processors, a recommended organization scheme of items in the defined space based on comparison of the baseline organization scheme with the user profile data for the organizer;
generating, by a number of processors, a presentation of the recommended organization scheme;
monitoring, utilizing a number of sensors, locations of items in the defined space relative to the recommended reorganization scheme; and
sending an alert to the organizer, by a number of processors, if locations of items in the defined space deviate from the recommended organization scheme beyond a predefined threshold.

2. The method of claim 1, wherein creating the baseline organization scheme further comprises categorizing items within the defined space.

3. The method of claim 1, wherein the user profile data includes at least one of:
user height;
health conditions;
physical limitations.

4. The method of claim 1, further comprising:
receiving, from a number of input devices, user profile data for a number of collaborators specified by the organizer as co-users of the defined space; and
wherein creating the recommended organization scheme of items in the defined space is based on comparison of the baseline organization scheme with the user profile data for the organizer and collaborators.

5. The method of claim 1, further comprising providing, by a number of output devices, indications to users to assist in locating and placing items in the defined space.

6. The method of claim 5, wherein the output devices comprise at least one of the following:
a visual indication on a user interface;
a light in the defined space that illuminates a selected item.

7. The method of claim 1, wherein monitoring the locations of items in the defined space is performed by at least one of the following:
cameras;
movement sensors;
weight sensors.

8. A system for automating organization of a defined space, the system comprising:
a bus system;
a storage device connected to the bus system, wherein the storage device stores program instructions; and
a number of processors connected to the bus system, wherein the processors execute the program instructions to:
receive, from a number of input devices, spatial data about the defined space;
receive, from a number of input devices, location data of objects in the defined space;
create a baseline organization scheme of objects in the defined space;
receive, from a number of input devices, user profile data for an organizer;
create a recommended organization scheme of items in the defined space based on comparison of the baseline organization scheme with the user profile data for the organizer;
generating, by a number of user interfaces, a presentation of the recommended organization scheme;
monitor, by a number of sensors, locations of items in the defined space relative to the recommended reorganization scheme; and
sending an alert to the organizer, by a number of output devices, if locations of items in the defined space deviate from the recommended organization scheme beyond a predefined threshold.

9. The system of claim 8, wherein creating the baseline organization scheme further comprises categorizing items within the defined space.

10. The system of claim 8, wherein the user profile data includes at least one of:
user height;
health conditions;
physical limitations.

11. The system of claim 8, wherein the processors further execute program instructions to:
receive, from a number of input devices, user profile data for a number of collaborators specified by the organizer as co-users of the defined space; and
wherein creating the recommended organization scheme of items in the defined space is based on comparison of the baseline organization scheme with the user profile data for the organizer and collaborators.

12. The system of claim 8, wherein the processors further execute program instructions to provide, by a number of output devices, indications to users to assist in locating and placing items in the defined space, wherein the output devices comprise at least one of the following:
a visual indication on a user interface;
a light in the defined space that illuminates a selected item

13. The system of claim 8, wherein monitoring the locations of items in the defined space is performed by at least one of the following:
cameras;
movement sensors;
weight sensors.

14. A computer program product for automating organization of a defined space, the program product comprising a non-volatile computer readable storage medium having program instructions embodied therewith and the program instructions executable by a computer to cause the computer to perform the steps of:
receiving spatial data about the defined space;
receiving location data of objects in the defined space;
creating a baseline organization scheme of objects in the defined space;
receiving user profile data for an organizer;
creating a recommended organization scheme of items in the defined space based on comparison of the baseline organization scheme with the user profile data for the organizer;
generating a presentation of the recommended organization scheme;
monitoring locations of items in the defined space relative to the recommended reorganization scheme; and
sending an alert to the organizer if locations of items in the defined space deviate from the recommended organization scheme beyond a predefined threshold.

15. The computer program product according to claim 14, wherein creating the baseline organization scheme further comprises categorizing items within the defined space.

16. The computer program product according to claim 14, wherein the user profile data includes at least one of:
user height;
health conditions;
physical limitations.

17. The computer program product according to claim 14, further comprising instructions for:
receiving user profile data for a number of collaborators specified by the organizer as co-users of the defined space; and
wherein creating the recommended organization scheme of items in the defined space is based on comparison of the baseline organization scheme with the user profile data for the organizer and collaborators.

18. The computer program product according to claim 14, further comprising instructions for providing, by a number of output devices, indications to users to assist in locating and placing items in the defined space.

19. The computer program product according to claim 18, wherein the output devices comprise at least one of the following:
a visual indication on a user interface;
a light in the defined space that illuminates a selected item.

20. The computer program product according to claim 14, wherein monitoring the locations of items in the defined space is performed by at least one of the following:
cameras;
movement sensors;
weight sensors.
